(19) United States
(12) Patent Application Publication
(10) Pub. No.: US 2010/0104119 A1
(43) Pub. Date: Apr. 29, 2010

(54) AUDIO OUTPUT DEVICE

(75) Inventor: YA-KE LAN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/550,862

(22) Filed: Aug. 31, 2009

(30) Foreign Application Priority Data
Oct. 24, 2008 (CN) 200810305189.X

(51) Int. Cl. H04R 5/02; H04R 1/10

(52) U.S. Cl. 381/309; 381/74; 381/384

(57) ABSTRACT

An exemplary audio output device includes a microprocessor, a voltage divider, an analog switch and an audio amplifier, which forming a loop circuit, and an audio jack. The audio jack is connected to the microprocessor and the analog switch. The microprocessor is further connected to the audio amplifier. When a earphone is plugged into the audio jack, the microprocessor receives an output voltage from the voltage divider, and adjusts the power of the audio amplifier. The audio jack is switched to be connected to the audio amplifier, and audio signals are output from the audio jack.

### BACKGROUND

1. Technical Field

The present disclosure generally relates to audio output devices, particularly, to an audio output device adjustable to different earphones.

2. Description of Related Art

Commonly, consumers employ earphones when listening to multimedia on their personal electronic devices, such as mobile phones and person digital assistants (PDAs). Consumers may use different earphones than the earphones that originally came with their electronic device. However, different earphones may have different impedances and not be able to perform at the volume level they were designed to perform at because they were not specifically designed for use with the present device.

Therefore, there is a room for improvement within the art.

### BRIEF DESCRIPTION OF THE DRAWINGS

Many aspects of an audio output device can be better understood with reference to the following drawings. The components in the drawings are not necessarily to scale, the emphasis instead being placed upon clearly illustrating the principles of the present audio output device. Moreover, in the drawings, like reference numerals designate corresponding parts throughout the several views.

FIG. 1 is a block diagram of an audio device according to an exemplary embodiment.

FIG. 2 is an inner circuit schematic of the audio output device connecting an earphone to a voltage divider according to the exemplary embodiment.

FIG. 3 is a work flow chart of the audio output device according to the exemplary embodiment.

### DETAILED DESCRIPTION OF THE EMBODIMENTS

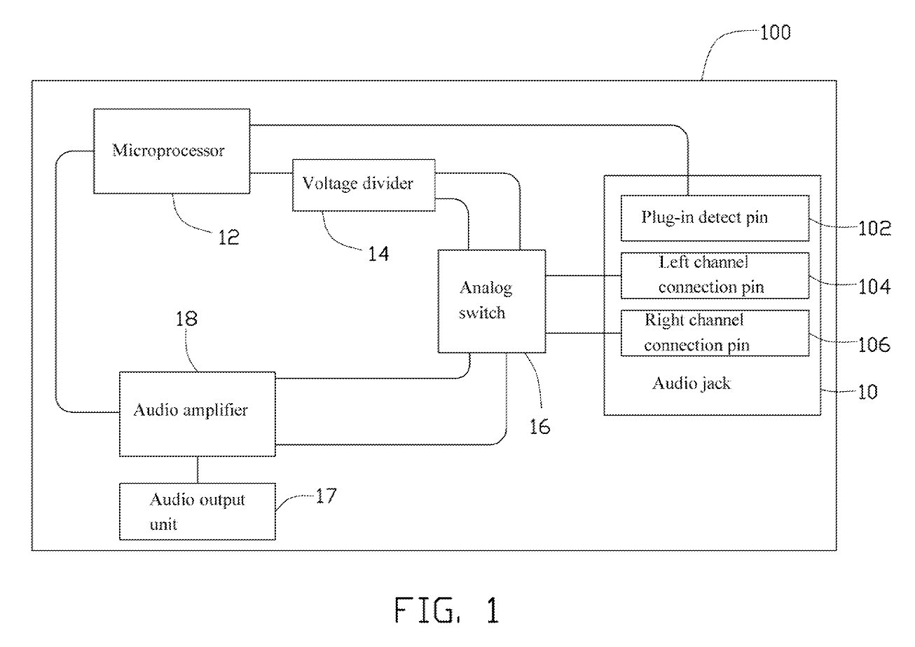

FIG. 1 shows an exemplary embodiment of an audio output device 100 for use in an electronic device having an audio output function, such as a mobile phone, a computer, an MP3 player etc. The audio output device 100 includes an audio jack 10, a microprocessor 12, a voltage divider 14, an analog switch 16, an audio output unit 17, and an audio amplifier 18. The exemplary embodiment of the audio output device 100 is suitable for two-channel stereo earphones. A battery (not shown) of the electronic device can be connected to the audio output device 100. The battery is configured for supplying electrical energy to the audio output device 100.

The audio jack 10 includes a plug-in detect pin 102 electronically connected to the microprocessor 12, a left channel connection pin 104, and a right channel connection pin 106. The left and the right channel connection pins 104, 106 are electronically connected to the analog switch 16.

The microprocessor 12, the voltage divider 14, the analog switch 16, and the audio amplifier 18 form a loop circuit. The audio jack 10 is used to receive a plug of an audio playing device, such as an earphone or a speaker. The microprocessor 12 is used to process the signals from the audio jack 10, the voltage divider 14, and the audio amplifier 18. The analog switch 16 is used to switch the connection path of the audio jack 10 to the voltage divider 14 or the audio amplifier 18. The audio output unit 17 is configured for outputting audio signals to the audio amplifier 18 and supplying audio signals to the left and right channel connection pins 104 and 106.

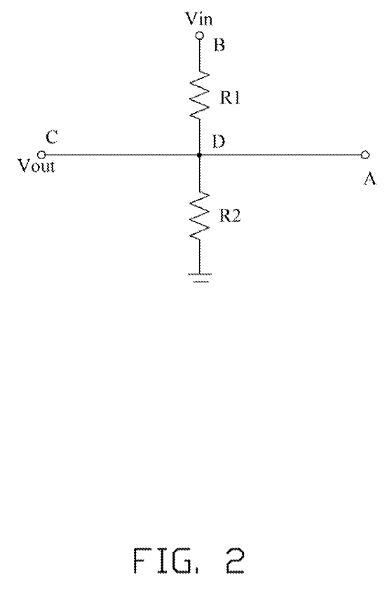

FIG. 2 shows an inner circuit schematic of the voltage divider 14 when the earphone is inserted into the audio jack 10. The voltage divider 14 includes an input end A, a reference voltage input end B, an output end C, a potentiometer R1 connected to the reference voltage input end B, and an earphone resistor R2 in series with the potentiometer R1.

The input end A is connected to the analog switch 16, the reference voltage input end B receives a reference voltage from the battery, and the output end C is connected to the microprocessor 12. The earphone resistor R2 connects with the ground (GND). The connection of the potentiometer R1 and the earphone resistor R2 forms a node D, and the input end A is further connected with the output end C through the node D. A reference voltage Vin is input to the input end B and sent to the potentiometer R1 and earphone resistor R2. The output voltage Vout of the voltage divider 14 is calculated as Vout=Vin*R2/(R1+R2). The output voltage of the audio amplifier 18 is set as V, then the output power W of the earphone is calculated as W=V*V/R2.

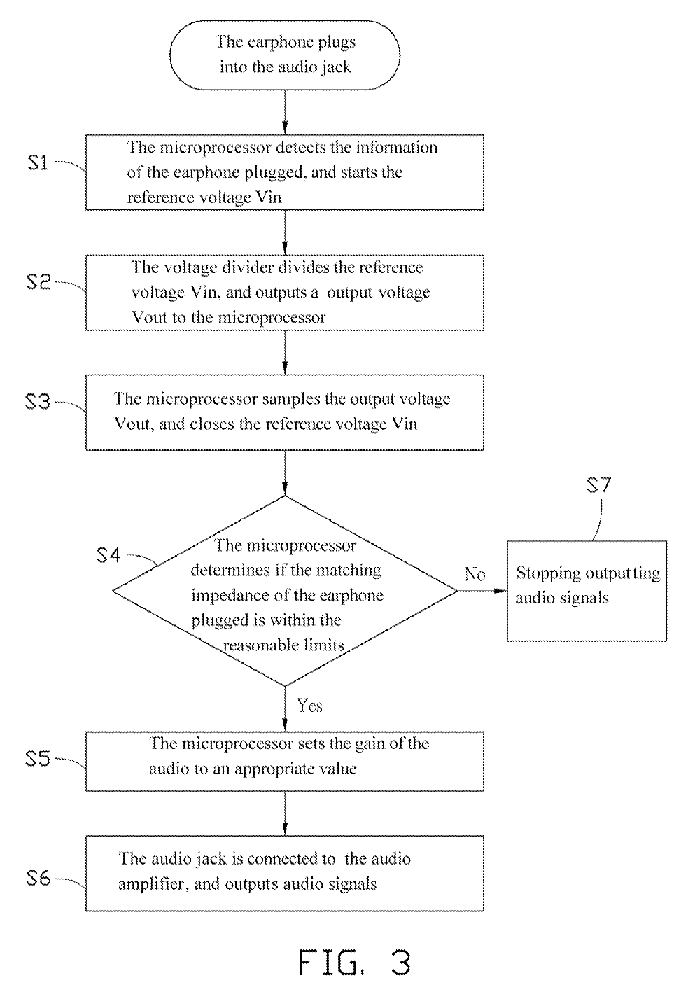

Referring to FIG. 3, in use, the operation of the audio output device 100 may include the following steps.

In step S1, the audio jack 10 is connected with the voltage divider 14 via the analog switch 16 when an earphone is plugged into the audio jack 10. The microprocessor 12 detects a plug-in message from the plug-in detect pin 102 and turns the reference voltage Vin on.

In step S2, the voltage divider 14 divides the reference voltage, and outputs the output voltage Vout to the microprocessor 12.

In step S3, the microprocessor 12 receives and samples the output voltage Vout, and turns off the reference voltage Vin.

In step S4, the microprocessor 12 verifies whether the impedance of the earphone is within a predetermined operational range or not according to the output voltage Vout. If the impedance of the earphone is within the operational range, then go to step S5. If the impedance of the earphone is not within the operational range, then go to step S7.

In step S5, the microprocessor 12 controls and sets the gain of the audio amplifier 18 to a predetermined and acceptable value, and automatically changes the output power of the audio amplifier 18 to maintain the sound volume level.

In step S6, the analog switch 16 switches the connection path of the audio jack 10 to the audio amplifier 18, so that the audio amplifier 18 is connected with the left and right channel connection pins 104 and 106 to output amplified audio signals to the earphone.

In step S7, the audio amplifier 18 stops outputting audio signals because the impedance of the earphone is not within the operational range as described in step S5.

For example, if Vin=2V, R1=16 ohm, R2=8 ohm, when the earphone is plugged into the audio jack 10, then the output voltage Vout of the voltage divider 14 is calculated as Vout=Vin*R2/(R1+R2)=2*[8/(16+8)]=0.667V. If the gain of the audio amplifier 18 is set to 1, then the output voltage V of the audio amplifier 18 is 2V. Thus, the output power W of the earphone is calculated as W=V*V/R2=2*2/8=0.5W.

If Vin=2V, R1=16 ohm, R2=32 ohm, when the earphone is plugged into the audio jack 10, then the output voltage Vout of the voltage divider 14 is calculated as Vout=Vin*R2/(R1+R2)=2*[32/(16+32)]=1.333V. The microprocessor 12 verifies the impedance of the earphone is within the predetermined operational range according to the output voltage Vout. If the gain of the audio amplifier 18 is still set to 1, then the output voltage V of the audio amplifier 18 is still 2V. However, the output power W of the earphone lowers to W=V*V/R2=2*2/32=0.125W. So to maintain the output power W of the earphone equal to 0.5W, then the gain of audio amplifier 18 is set to 4, and the output voltage Vout of the audio amplifier 18 rises to 4V, then the output voltage V of the audio amplifier 18 is 4V, and the output power W of the earphone is calculated as W=V*V/R2=4*4/32=0.5W. Therefore, the output power of earphone with 32 ohm is equal to the output power of earphone with 8 ohm.

According to above description, if the microprocessor 12 detects the output voltage Vout of the voltage divider 14 is 0.667V, then the gain of the audio amplifier 18 is set to 1. If the microprocessor 12 detects the output voltage Vout of the voltage divider 14 is 1.333V, then the gain of the audio amplifier 18 will be set to 4 to automatically adjust the output power of the earphone.

The audio output device 100 can detect the impedance of the earphone plugged into the audio jack 10, and automatically adjust the output power to automatically adjust the sound volume of the earphone. The audio output device 100 is suitable for different earphones, and can guarantee sound quality of the earphones.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An audio output device, comprising:
an audio jack for receiving a plug of an earphone;
a microprocessor electronically connected to the audio jack;
a voltage divider electronically connected to the microprocessor;
an analog switch electronically connected to the voltage divider and the audio jack, and configured to switch the connection path of the audio jack to the voltage divider or the audio amplifier; and
an audio amplifier electronically connected to the microprocessor and the analog switch, wherein when the plug of the earphone is plugged into the audio jack, the analog switch switches the connection path of the audio jack to the voltage divider, the voltage divider outputs a output voltage to the microprocessor, the microprocessor determines the impedance of the earphone plugged into the audio jack according to the output voltage from the voltage divider, and automatically adjusts the output power of the audio amplifier, the audio jack is disconnected with the voltage divider and switched to connect to the audio amplifier, audio signals are output from the audio jack.

2. The audio output device as claimed in claim 1, wherein the audio jack comprises a plug-in detect pin electronically connected to the microprocessor, a left channel connecting pin and a right channel connecting pin, both the left and right channel connecting pins connected to the analog switch.

3. The audio output device as claimed in claim 1, wherein the voltage divider comprises an input end, a reference voltage input end, an output end, a potentiometer connected to the reference voltage input end, and an earphone resistor electronically connected in series with the potentiometer, the input end is connected to the analog switch, the reference voltage input end is used to receive a reference voltage, the output end is connected to the microprocessor, and the earphone resistor is connected to the GND (Ground).

4. The audio output device as claimed in claim 3, wherein the connection of the potentiometer and the earphone resistor forms a node, the input end is further connected to the output end through the node, and the input end selectively inputs the reference voltage to the potentiometer and earphone resistor.

5. The audio output device as claimed in claim 3, wherein the microprocessor detects a plug-in message of the earphone plugged into the audio jack from the plug-in detect pin, and turns the reference voltage on.

6. The audio output device as claimed in claim 4, wherein the voltage divider divides the reference voltage, and outputs the output voltage to the microprocessor.

7. The audio output device as claimed in claim 6, wherein the microprocessor receives and samples the output voltage, and turns off the reference voltage.

8. The audio output device as claimed in claim 7, wherein the microprocessor verifies whether the impedance of the plug of the earphone is within a predetermined operational range or not according to the output voltage Vout from the voltage divider.

9. The audio output device as claimed in claim 8, wherein if the microprocessor determines the impedance of the earphone is within the operational range, then the microprocessor controls and sets a gain of the audio amplifier to an acceptable value, automatically adjusts the out power of the audio amplifier to keep up the sound volume, and the analog switch switches the connection path of the audio jack to the audio amplifier, and the audio amplifier is connected with the left and right channel connection pins to output amplified audio signals to the earphone.

10. The audio output device as claimed in claim 9, wherein if the microprocessor determines the impedance of the earphone is not within the operational range, then the microprocessor interrupts the output power of the audio amplifier and stops outputting audio signals.

11. The audio output device as claimed in claim 1, further comprising an audio output unit electrically connected with the audio amplifier, the audio output unit is configured for outputting audio signal to the audio amplifier and supplying audio signals to the channel connection pins.
